(19) United States
(12) Patent Application Publication
(10) Pub. No.: US 2001/0022045 A1
(43) Pub. Date: Sep. 20, 2001

(54) Fishing lure retriever

(76) Inventor: Anthony Hiley, Comox (CA)

Correspondence Address: GLENN PATENT GROUP, 3475 EDISON WAY, SUITE L, MENLO PARK, CA, 94025, US

(21) Appl. No.: 09/804,600

(22) Filed: Mar. 12, 2001

(30) Foreign Application Priority Data
Mar. 14, 2000 (CA) 2,300,541

(51) Int. Cl. A01K 97/00

(52) U.S. Cl. 43/17.2

(57) ABSTRACT

A fishing lure retriever having a teardrop-shaped weight of lead or similarly dense material. Clipping means are attached to the weight. The weight and clipping means are coated in a thin layer of vinyl or similar resilient material. Where a fishing lure has become entangled underwater, the retriever is attached to the fishing line and permitted to descend by gravity along the line to the point of entanglement. Motion of the fishing line with the retriever in place near the entangled lure results in controlled movement of the weight near the entangled lure effecting disengagement of the lure.

### TECHNICAL FIELD OF THE INVENTION

The present invention relates generally to sport fishing equipment, and more particularly to a device for underwater retrieval of an entangled fishing lure.

### BACKGROUND OF THE INVENTION

It is known to provide a device for disengaging a fishing lure which has become entangled beneath the water while in use. Examples of such a device include U.S. Pat. No. 3,643,366 to Gates, U.S. Pat. No. 3,754,345 to Whitehead and U.S. Pat. No. 2,940,203 to Carter.

Many of the prior art devices, such as Gates '366 and Whitehead '345, require attachment of the dislodging device to a retrieval line which is made to descend along the fishing line towards the entangled lure. Prior art devices which require such a line are not ideal as this second line may become wound around the fishing line or become entangled in the lure or in the obstacle holding the lure, thereby reducing the effectiveness of the device in dislodging the entangled lure.

In Carter '203, the dislodging device is attached to the end of a pole which is run along the fishing line to the entangled lure. While less likely than a line to become entangled, such a pole clearly has limitations with respect to the depth to which it can be used to dislodge a lure.

With the devices described in U.S. Pat. No. 4,930,244 to Enwiller and U.S. Pat. No. 3,531,887 to Bortle, in addition to requiring a second retrieval line, the mechanism by which the entangled lure is disengaged involves snagging non-entangled hooks of the entangled lure within a mesh-like arrangement on the device. These lure retrievers are less than ideal for disentangling lures which comprise only one hook, as there would be no freely suspended hooks on the lure available to engage the mesh of the retriever.

U.S. Pat. No. 4,301,610 to Brown describes a fishing lure retriever comprising a hook for attachment to a fishing line and a weighted disk suspended from the hook. The retriever of Brown '610 is intended to be released to descend along the fishing line. However, the non-uniformity of surface shape of the weighted disk would result in uneven drag forces as the weight rotates during its descent. Such uneven drag would vary the rate of descent of the retriever and reduce its effectiveness as a counterweight to disengage an entangled lure.

There are a number of desirable objectives in relation to fishing lure retrievers. Such retrievers should ideally be compact for ease of transport and storage. They should be simple in design to allow quick and easy use, allowing a prompt return to fishing. There should be no requirement for a second retrieval line or pole to be attached to the device to enable its descent to an entangled lure. Ideally, the device should be of a design which will be resistant to entanglement and exhibits minimal drag in water.

The device should provide a counterweight to provide leverage at the point of entanglement and an easy to use attachment means for connecting the device to a fishing line. Ideally, there should be restricted movement of the counterweight about the connection between the counterweight and the attachment means. There should be no need to retie the lure after retrieval, and the retrieval device should not cause any damage to the retrieved lure.

Existing fishing lure retrievers achieve some of these objectives, but with varying degrees of success. For example, the device in Enwiller '244 is relatively bulky and requires a second retrieval line to effect its descent. The device in Gates '366 comprises multiple hooks which are liable to become entangled underwater. The counterweight retriever described in Brown '610 is compact and does not require a second line, but it exhibits uninhibited rotation of the counterweight relative to the hook used to attach it to the fishing line. Such freedom of rotation is not ideal. It is preferable to restrict the motion of the counterweight to maximize its effectiveness in freeing an entangled lure.

It is an object of the present invention to provide a fishing lure retriever which does not require a second retrieval line, and which is compact and simple in design to allow ease of transport, storage and use, allowing a prompt return to fishing.

It is a further object of the present invention to provide such a device which does not damage an entangled lure, and which does not necessitate retying of the lure once retrieved.

It is yet another object of the present invention to provide such a retriever having a weight which is generally uniform in vertical cross-section to reduce drag in the water.

It is still a further object of the present invention to provide such a device which restricts the pivoting action of the counterweight to maximize the leverage effected by the device at the point of entanglement of the lure.

### SUMMARY OF THE INVENTION

In one of its aspects, the fishing lure retriever according to the invention comprises a weight, clipping means connected to the upper end of the weight by articulated connecting means, and articulation limiting means.

In another of its aspects, the invention comprises such a fishing lure retriever in which the articulation limiting means comprise a resilient coating encasing the weight and the articulated connecting means.

In yet another of its aspects, the invention comprises such a fishing lure retriever in which the thickness of the coating is between 0.05 and 2.0 millimeters.

In still another of its aspects, the invention comprises such a fishing lure retriever in which the coating is vinyl.

In a further of its aspects, the invention comprises a fishing lure retriever in which the articulated connecting means comprise a first closed loop fixedly connected to the top of the weight and interconnected with a second closed loop fixedly connected to the clipping means, and in which the weight is of uniform vertical cross-section.

In yet a further of its aspects, the invention comprises a fishing lure retriever having a drop-shaped weight permanently connected to clipping means by articulated connecting means comprising a first closed loop fixedly connected to the top of the weight and interconnected with a second closed loop fixedly connected to the clipping means, and a vinyl coating of a thickness of between 0.05 and 2.0 millimeters encasing the weight and articulated connecting means.

In still a further of its aspects, the invention comprises such a fishing lure retriever in which the clipping means comprises a reversibly engageable clip.

Other aspects of the invention will be appreciated by reference to the description of the preferred embodiment which follows and to the claims.

### BRIEF DESCRIPTION OF THE DRAWINGS

The invention will be described by reference to the preferred embodiment and the drawings thereof in which:

FIG. 1 is a perspective front view of the retriever according to the invention;

FIG. 2 is a perspective side view of the retriever according to the invention;

FIG. 3 is a cross-sectional view of the retriever according to the invention through line 3-3 of FIG. 2; and

FIG. 4 is a cross-sectional view of the retriever according to the invention through line 4-4 of FIG. 1; and

FIG. 5 is a perspective front view of the retriever according to the invention showing the retriever attached to a fishing line.

### DETAILED DESCRIPTION OF BEST MODE AND PREFERRED EMBODIMENT OF THE INVENTION

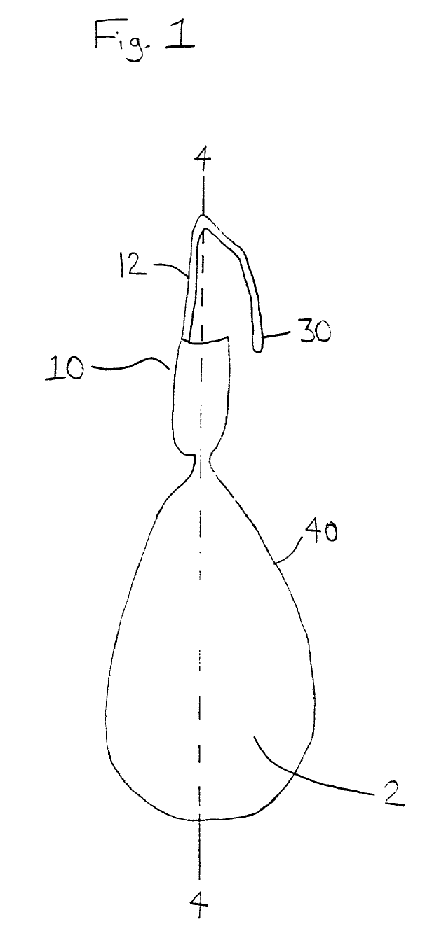

As shown in FIGS. 1 through 4, the fishing lure retriever according to the present invention comprises a drop-shaped weight 2 through which a central pin 5 extends longitudinally. The pin 5 is flattened at its bottom end 6 to prevent its exit from the weight. The top end of the pin comprises a first closed loop 8.

The teardrop shape of the weight 2 provides a structure which is uniform in cross-section about its vertical axis. Such a uniform structure enables the weight to present a relatively constant surface area when descending through water along a fishing line to which it is attached from its top end. As a result, the drag resulting from the descent of the retriever does not change as the device rotates about its vertical axis. Uniform drag results in uniform acceleration as the retriever descends towards the entangled lure, maximizing impact of the retriever upon reaching an entangled lure and increasing the likelihood of knocking the lure free.

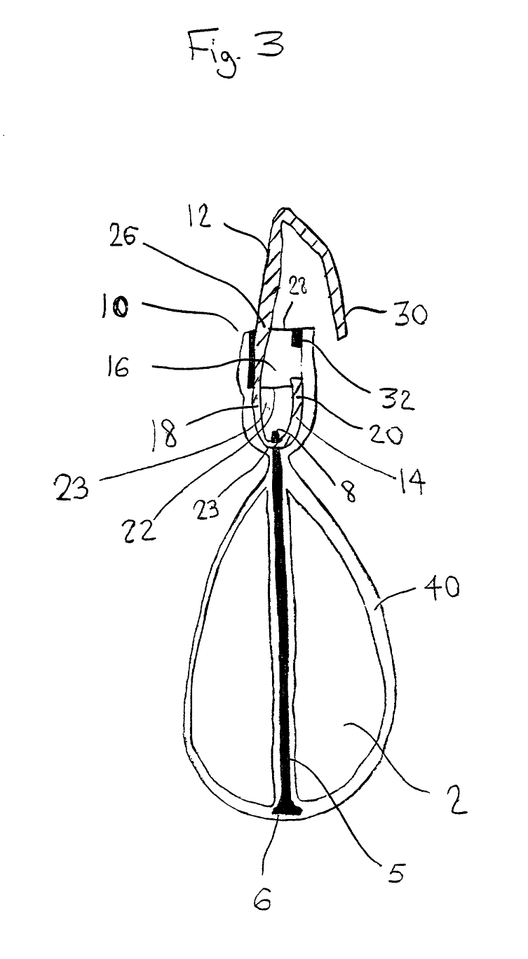

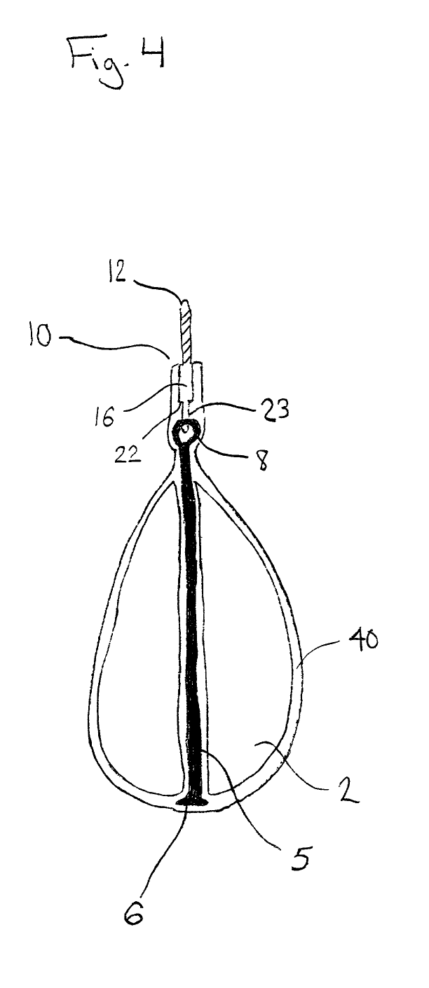

As shown in FIGS. 3 and 4, the clipping means 10 of the invention comprises top 12 and bottom 14 U-shaped loops joined together by a flat plate 16. Ends 18, 20 of the bottom U-shaped loop 14 are permanently fixed to opposite sides of the bottom edge 22 of the plate 16, forming a second closed loop 23 which is linked with the closed loop 8 of the pin 5 of the retriever device. The linking of the closed loops allows articulation of the weight relative to the clipping means.

One end 26 of the top U-shaped loop 12 is permanently fixed to one side of the top edge 28 of the plate 16. The other end 30 of the top U-shaped loop 12 is reversibly attached to locking means 32 on the opposite side of the top edge 28 of the plate 16. The locking means 32 comprise an extension of the plate 16 which curls back upon itself to create a channel into which the second end 30 of the top U-shaped loop 12 may be removably inserted upon application of an inward force theron.

In the preferred embodiment of the invention, the weight 2 is comprised of lead, bronze or similar high density material.

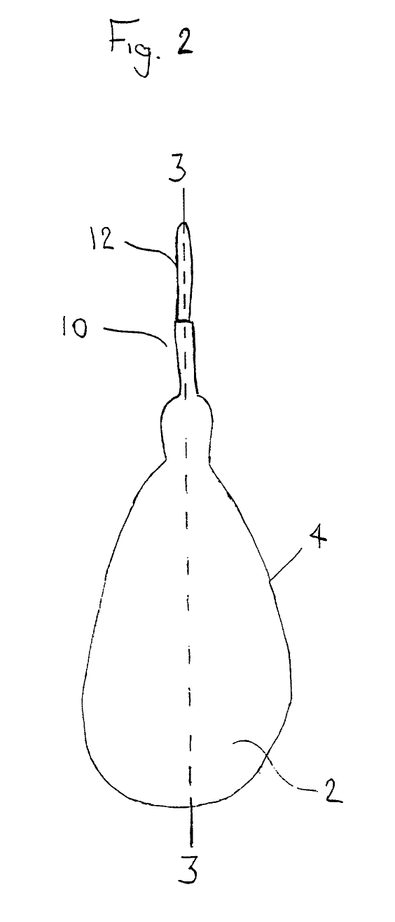

Referring now to FIGS. 1 and 2, the weight 2, pin 5 and closed loop 23 of the clipping means 10 are coated in vinyl or similar resilient coating 40 of a particular thickness. The effect of the coating 40 is to limit the articulation of the weight 2 relative to the clipping means 10 about the point of connection between them. Without such a coating, the weight pivots freely in all directions, reducing the effectiveness of the retriever by reducing the ability of an angler to control the motion of the weight.

The thickness of the coating determines the degree to which movement of the weight relative to the clipping means is restricted. With no coating, such movement is virtually not restricted at all. A very thick coating of vinyl would completely prevent movement of the weight relative to the clip. The thickness of the coating according to the present invention is any thickness which partially restricts the motion of the weight relative to the clipping means about their point of connection.

In the preferred embodiment of the invention, the vinyl is between 0.05 and 2 millimeters thick, and is of a composition which maintains flexibility at temperatures below the freezing point of fresh water.

The limited motion of the weight enables an angler attempting to retrieve a lure which has become entangled to more effectively employ the weight of the lure retriever to maximize the leverage effected by the retriever in proximity to the entangled lure than would be the case where the weight was free to pivot in all directions.

When used to disentangle a lure, the retriever device is made to descend to the site of the entangled lure. Upon reaching the lure, the clipping mechanism rests against the lure. As force if applied to the fishing line by an angler, such force is transferred through the clipping means to the weight, causing the weight to move to a limited degree. The force of the moving weight in proximity to the entangled lure causes movement and disentanglement of the entangled lure. Without the vinyl coating, the force imparted by the angler to the line would not be effectively transferred to the weight, as the clipping means would have a wide range of movement relative to the uncoated weight.

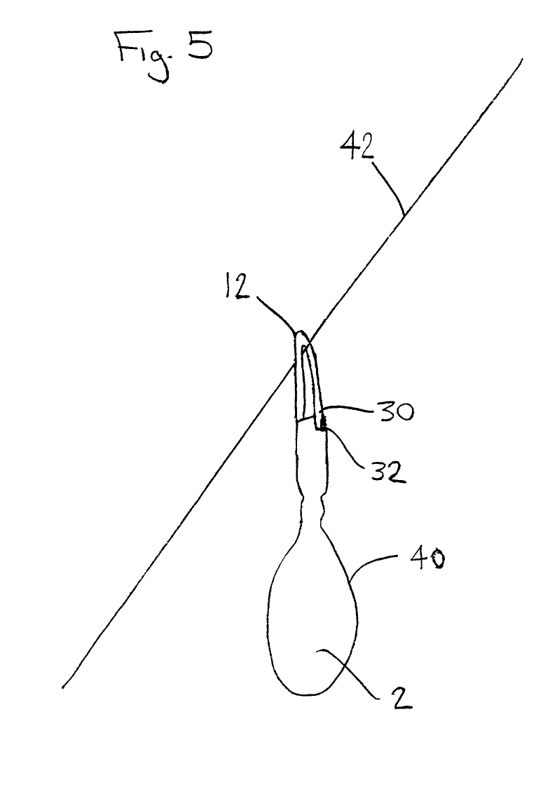

When a lure becomes entangled, the angler depresses the movable end 30 of the non-coated loop 12 of the clipping means 10 to open the clip. As shown in FIG. 5, the open clip is then placed around the line 42 of an entangled lure and the movable end 30 again depressed so as to lock the clip around the line 42. The retriever is then permitted to descend by gravity along the line to the vicinity of the entangled lure. Once it has reached its destination, the retriever adds leverage to the angler's attempts to disengage the lure by movement of the fishing rod. Once the lure is disengaged, the lure and retriever can be reeled in. The retriever is then detached from the line, and the lure is again ready for use.

The fishing lure retriever according to the present invention is designed to allow ease of attachment to an entangled lure line and minimize drag during the descent of the retriever, while enabling a restricted pivotal action of the weighted end of the device relative to the means of attachment to the fishing line.

The fishing lure retriever according to the present invention is further designed to allow ease of retrieval of an entangled lure, as well as recovery of the retriever itself. In previous devices, retrieval of the entangled lure could cause damage to the lure or to the retriever, at considerable cost to the angler. The device of the present invention is not damaged by use and can be reused repeatedly.

It will be appreciated by those skilled in the art that other variations of the preferred embodiment may also be practised without departing from the scope of the invention.

What is claimed is:

1. A fishing lure retriever device comprising:
a weight,
clipping means connected to the upper end of the weight by articulated connecting means, and
articulation limiting means.

2. The device of claim 1 wherein the articulation limiting means comprise a resilient coating encasing the weight and the articulated connecting means.

3. The device of claims 1 or 2 wherein the thickness of the coating is between 0.05 and 2.0 millimeters.

4. The device of claims 1 or 2 wherein the coating is comprised of vinyl having a thickness between 0.05 and 2.0 millimeters.

5. The device of claims 1 or 2 wherein the articulated connecting means comprise a first closed loop fixedly connected to the top of the weight and interconnected with a second closed loop fixedly connected to the clipping means.

6. The device of claims 1 or 2 wherein the coating is comprised of vinyl having a thickness between 0.05 and 2.0 millimeters and the articulated connecting means comprise a first closed loop fixedly connected to the top of the weight and interconnected with a second closed loop fixedly connected to the clipping means.

7. The device of claims 1 or 2 wherein the weight is of uniform vertical cross-section.

8. The device of claims 1 or 2 wherein the coating is comprised of vinyl having a thickness between 0.05 and 2.0 millimeters, the articulated connecting means comprise a first closed loop fixedly connected to the top of the weight and interconnected with a second closed loop fixedly connected to the clipping means, and the weight is of uniform vertical cross-section.

9. A fishing lure retriever device comprising:
a weight having a drop shape,
clipping means permanently connected to the weight by articulated connecting means comprising a first closed loop fixedly connected to the top of the weight and interconnected with a second closed loop fixedly connected to the clipping means, and
a vinyl coating of a thickness of between 0.05 and 2.0 millimeters encasing said weight and articulated connecting means.

10. The fishing lure retriever of claims 1 or 2 wherein said clipping means further comprises a reversibly engageable clip.

11. The fishing lure retriever of claims 1 or 2 wherein said clipping means further comprises a reversibly engageable clip, the articulated connecting means comprise a first closed loop fixedly connected to the top of the weight and interconnected with a second closed loop fixedly connected to the clipping means, and the coating is comprised of vinyl having a thickness between 0.05 and 2.0 millimeters.
